(19) United States
(12) Patent Application Publication
(10) Pub. No.: US 2012/0280105 A1
(43) Pub. Date: Nov. 8, 2012

(54) MOLD FOR MELTABLE FREE-STANDING SHOOTING TARGETS

(75) Inventor: Matthew Gene Dunbar, Jonesville, MI (US)

(73) Assignee: Eco-Target, L.L.C., Hillsdale, MI (US)

(21) Appl. No.: 13/463,459

(22) Filed: May 3, 2012

Related U.S. Application Data
(60) Provisional application No. 61/481,824, filed on May 3, 2011.

(51) Int. Cl. B28B 7/26; B28B 7/24

(52) U.S. Cl. 249/126; 249/119

(57) ABSTRACT

A mold for making a free-standing target from a frozen water-based liquid which includes at least one open-mold cavity configured to form a free-standing target. The open-mold cavity has a first portion and a second portion. The first portion has a first depth and a first portion vertical length. The second portion has a second portion vertical length, and a substantially planar support surface. The second portion is contiguous with the first portion. The substantially planar support surface is configured to support the free-standing target on a surface where a depth at or about the support surface is greater than the first depth of the first portion. The open-mold cavity has a total vertical length, and the vertical length of the first portion is at least 0.60 the total vertical length.

### CROSS-REFERENCE TO RELATED APPLICATIONS

This application claims the benefit of U.S. provisional application No. 61/481,824, filed May 3, 2011 (the '824 application). The '824 application is hereby incorporated by reference as though fully set forth herein.

### TECHNICAL FIELD

This disclosure relates generally to molds for providing frozen articles in predetermined shapes.

### BACKGROUND

In various fields, persons in the art may practice their aim and shooting abilities with a number of devices, such as guns, slingshots, bows, and the like, and may utilize certain objects or targets. Some objects or targets may be more desirable than others, for instance, taking into account a shattering effect when an object is hit. For example, targets made for practice shooting are commonly made out of clay. When a clay target is hit, the target is typically designed to shatter into multiple fragments. However, the shattered remains of the target are then left for cleanup, and may present a hazard, particularly if the shattered remains include sharp portions.

Among other things, it can be desirable to provide a target for shooting practice that shatters upon impact with a projectile, but which does not require collection of the shattered remains of the target.

### BRIEF SUMMARY

A mold for making a free-standing target from a frozen water-based liquid which includes at least one open-mold cavity configured to form a free-standing target. The open-mold cavity has a first portion and a second portion. The first portion has a first depth and a first portion vertical length. The second portion has a second portion vertical length, and a substantially planar support surface. The second portion is contiguous with the first portion. The substantially planar support surface is configured to support the free-standing target on a surface where a depth at or about the support surface is greater than the first depth of the first portion. The open-mold cavity has a total vertical length, and the vertical length of the first portion is at least 0.60 the total vertical length.

A mold for making free-standing shooting targets made from a frozen water-based liquid may comprise at least one first open-mold cavity and at least one second open-mold cavity. The first open-mold cavity may be configured to form a first free-standing target. The first open-mold cavity may have a first portion and a second portion. The first portion of the first open-mold cavity may be substantially cylindrical in shape. The second portion of the first open-mold cavity may be generally rectangular in shape. The first portion and the second portion of the first open-mold cavity may be integrally connected, and a depth of the first portion of the first open-mold cavity may be smaller than a depth of the second portion of the first open-mold cavity relative to a top surface of the mold. The second open-mold cavity may be configured to form a second free-standing target. The second open-mold cavity may have a first portion and a second portion. The first portion of the second open-mold cavity may be substantially cylindrical in shape. The second portion of the second open-mold cavity may be generally rectangular in shape. The first portion and the second portion of the second open-mold cavity may be integrally connected, and a depth of the first portion of the second open-mold cavity may be smaller than a depth of the second portion of the second open-mold cavity relative to a top surface of the mold. A volume of the first open-mold cavity may be larger than a volume of the second open-mold cavity.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 generally illustrates an isometric view of an embodiment of an open cavity mold configured for making free-standing shooting targets.

FIG. 2 is a cross-sectional view of the embodiment of the mold illustrated in FIG. 1.

FIG. 3 is a front view of an embodiment of a free-standing shooting target, such as generally formed in connection with the mold shown in FIG. 1.

FIG. 4 is a side view of the embodiment of a free-standing shooting target generally illustrated in FIG. 3.

### DETAILED DESCRIPTION

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

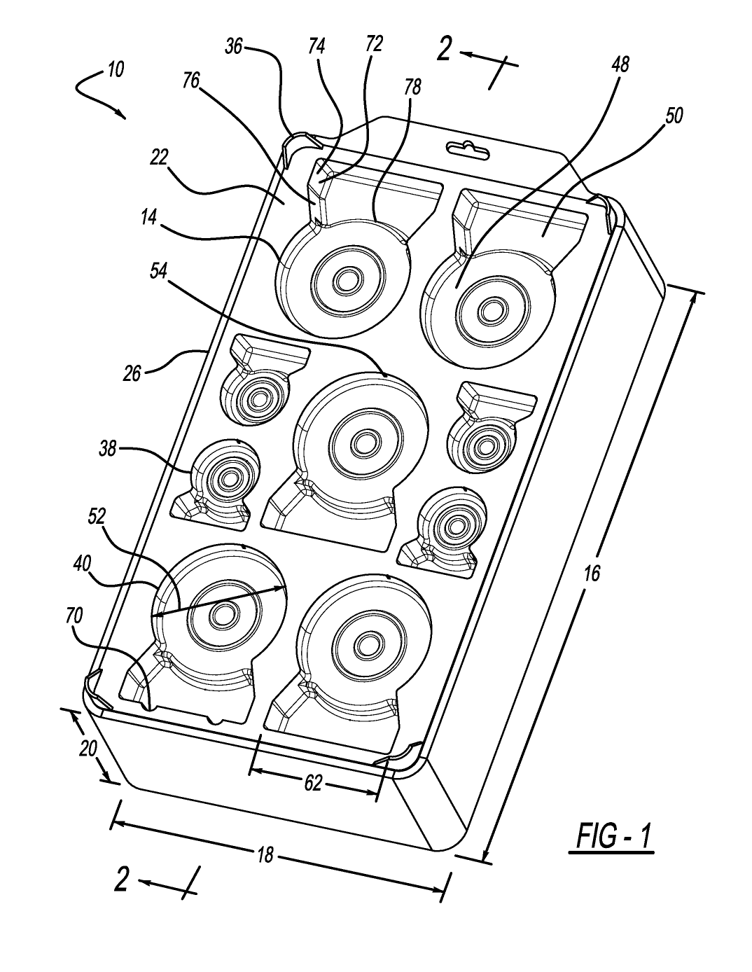

Referring now to the drawings wherein like reference numerals are used to identify identical components in the various views, FIG. 1 generally illustrates a mold 10 for making at least one free-standing shooting target 12 (an embodiment of a free-standing shooting target 12 is generally illustrated in FIGS. 3 and 4). The mold 10 may comprise at least one open-mold cavity 14 configured to form a free-standing target 12. In embodiments, water or a water-based liquid may be dispensed into one or more open-mold cavities 14. It is noted, however, that other liquid or semi-solid material that can be morphed into a solid state may also be used to make the free-standing targets 12. The liquid or semi-solid material may be biodegradable and/or environmentally friendly such that little to no clean-up is required after use. For many applications water can work well, as it is inexpensive, readily available, environmentally friendly, and results in little or no clean-up after use. Because the cavities 14 may be open, the dispensing of water or water-based liquid into the cavities 14 may be done relatively quickly, such as at a sink or with a bottle containing water or a water-based liquid. Moreover, with an open configuration of cavities 14, a user is able to adjust the thickness of one or more targets 12 according to personal preference. The user may choose to fill all open-mold cavities 14 to the same or substantially similar thickness or may instead fill the open-mold cavities 14 to varying thicknesses. Also, for some embodiments/applications, the water or water-based liquid may be colored, for example, by mixing in a coloring additive prior to dispensing the water or water-based liquid into one or more open-mold cavities 14. The inclusion of coloring can, among other things, make all or portions of a free-standing target 12 more distinctive and/or visible to a user. Alternatively, a coloring agent or medium may be applied to the outer surface of a portion of a free-standing target 12 post-molding, such as after a target 12 is formed and removed from a mold 10.

Once a given or desired amount of water or water-based liquid is provided in one or more open-mold cavities 14, the mold 10 may be placed inside a freezer or other device in which the water or water-based liquid may solidify. With embodiments, the mold 10 may have a length 16, a width 18, and a height (or depth) 20. In an embodiment, such as to fit conveniently inside a typical household freezer, the length 16 may be about 13⅞ inches, the width 18 may be about 8 5/16 inches, and the height 20 may be about 29/32 inches. In an embodiment, the user may position or lay the mold 10 substantially flat with the cavity 14 facing upward. With the self-leveling properties of water and many water-based liquids, the thicknesses of an individual target 12 in a mold may be substantially uniform throughout certain respective portions.

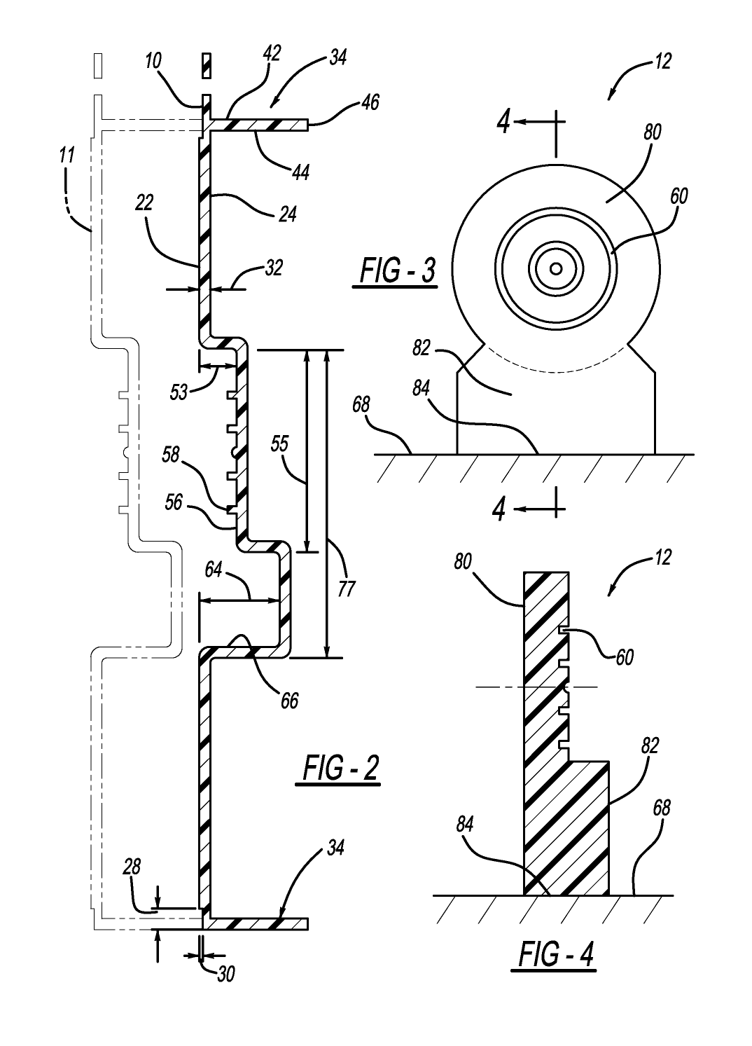

Referring to FIGS. 1 and 2, the mold 10 may include a top surface 22 and a bottom surface 24 (the bottom surface 24 may be best seen in FIG. 2). The top surface 22 may be substantially flat in some areas and in other areas be configured to form at least one open-mold cavity 14. The mold 10 may be rectangular in shape, but can also take on a variety of other shapes, such as but not limited to, a triangle, a square, a pentagon, or an octagon. The bottom surface 24 may rest on a freezer surface and may be configured to allow the mold 10 to lie flat. Once solidified, the free-standing targets 12 may be removed from the mold 10. For ease in removal, the mold 10 may first be removed from the freezer and left at room temperature for three to four minutes.

To remove the solidified free-standing targets 12 from the mold 10, the user may grab opposite ends of the mold 10 and gently twist with both hands in opposite directions simultaneously. The user may also gently apply force to the bottom surface 24 of the mold 10 to aid in loosening the free-standing targets 12 from their respective open-mold cavities 14. Additionally, the open-mold cavities 14 may have a draft angle on each wall of the cavity 14 to promote removal of the free-standing targets 12 from the mold 10. The material of the mold 10 may be high-density polyethylene or other type of plastic as known to those with skill in art. The properties of plastic make it a suitable material for the mold 10, namely its durability and elasticity. Durability is desired so that the mold 10 may be used repeatedly to create multiple free-standing targets, and elasticity is desired so that the mold 10 may be deformed slightly and temporarily (when removing the free-standing targets 12) without causing permanent deformation to the mold 10.

As seen in FIG. 1, the mold 10 may include a slight recess 26 along a perimeter of the top surface 22. The recess 26 may be configured as an alignment aid when a plurality of molds 10 are stacked on top of each other. The recess 26 may have a width 28 and a depth 30 (as best seen in FIG. 2), where the depth 30 may be relative from the top surface 22 of the mold 10. In an embodiment, the width 28 may be 3/16 inches and the depth 30 may be 1/16 inches. In an embodiment, the width 28 of the recess 26 may be slightly greater than a thickness 32 (described in further detail below) of the mold 10. For example, in an exemplary embodiment, the width 28 of the recess 26 may be 3/16 inches and the thickness 32 of the mold 10 may be 5/32 inches. As seen in FIG. 2, this configuration may allow the plurality of molds 10 to nest together where a second mold 11 having a skirt 34 (described in further detail below) would engage the recess 26 of the first mold 10 located below the second mold 11.

In addition to the recess 26, the mold 10 may further include a plurality of locators 36. Each locator 36 of the plurality of locators 36 may be located proximate to a corner of the top surface 22 of the mold 10 and protrude from the top surface 22 of the mold 10. In an embodiment, the mold 10 may have four locators 36, with each locator 36 being aligned with one of the four corners of the top surface 22 of the mold 10. The locators 36 may be positioned at the outermost edge of the top surface 22, adjacent to the recess 26. The locators 36 may be shaped to align with an inner surface 44 of the skirt 34 of a second mold 11 placed on top of the first mold 10. While the other mold 11 is placed on top of the mold 10, the bottom surface 46 of the skirt 34 of the other mold 11 may lie in the recess 26 of the mold 10. In an embodiment, the locators 36 may be generally L-shaped. The locators 36 may have a height relative to the top surface 22 of the mold 10. In an embodiment, the height of the locator 36 may be 5/32 inches. In an embodiment, the legs of the locators 36 may be equidistant in length. In an embodiment, the length of the legs may be about 3/4 inches. In an embodiment, each of the legs of the locators 36 may be chamfered. The mold 10 may have at least three corners (e.g., triangular-shaped mold 10), and the corners may also be rounded. One of ordinary skill in the art will recognize that there are other ways to align one mold 10 with another mold 11 for stacking purposes. For instance, the recess 26 may be deep enough so that the skirt of the other mold 11 lies snuggly thereupon. Alternatively, the locator 36 may be located elsewhere other than near the corners. Moreover, the locator 36 may also be female rather than male, and the other mold 11 stacked on top of the mold 10 may include a locator 36 on the skirt or a hollowed portion located on the underside of the mold 10.

As seen in FIG. 1, the mold 10 may include one or several open-mold cavities 14. The cavities 14 may be the same size or different sizes. In an embodiment, the mold 10 may have small size cavities 38 and large size cavities 40. The shape of the cavities 14 may be the same or different. In an embodiment, the mold 10 may be divided into three rows: a first row, a second row, and a third row. The first row may include two large size cavities 40, the second row (which is located in between the first and third rows) may include one large size cavity 40 and four small size cavities 38, and the third row may include two large size cavities 40. The cavities 14 may have a volume. In an embodiment, the large size cavity 40 may have a larger volume than the small size cavity 38.

Reference is now made to FIGS. 2 and 3. FIG. 2 is a cross-sectional view of an embodiment of the mold 10 seen in FIG. 1 taken from line 2-2. FIG. 3 is a general illustration of an embodiment of the free-standing target 12 that may be formed from the cavity 14 in the mold 10.

As seen in FIG. 2, the mold 10 may have the thickness 32 that may be relatively constant throughout. The mold 10 may have the hollowed portion, and the general shape of the open-mold cavities 14 may be apparent upon viewing the hollowed portion. With relatively constant thickness 32 throughout, the mold 10 may require less plastic (or other material).

The mold 10 may also include the skirt 34 along the perimeter of the top surface 22 that extends downwardly from the top surface 22 of the mold 10 to rest on a freezer surface. The skirt 34 may have an outer surface 42, along with the inner surface 44 and the bottom surface 46. In an embodiment, the skirt may have a constant length measured from the recess 26 to the bottom surface 46 of the skirt 34 that is substantially similar to the height 20 of the mold 10. The skirt 34 does not need to go around the entire perimeter of the mold 10; moreover, in an embodiment, the mold 10 may not have a skirt 34. The bottom surface 46 of the skirt 34 (as best seen in FIG. 2) may rest on a freezer surface and is configured to allow the mold 10 to lie flat. The skirt 34 may make it easier for the user to grip the mold 10 and twist upon removing the targets 12 from the cavities 14.

As previously disclosed, the mold 10 may have at least one cavity 14 or a plurality of cavities 14. While various sized cavities 14 have been referred to, reference will be now be made to one cavity 14, but the descriptions disclosed herein may be applicable to each cavity 14 of the plurality of cavities 14.

Referring to FIGS. 1-3, the cavity 14 may include a first portion 48 and a second portion 50. The first portion 48 may be configured to shape the portion of the target 12 that serves as the “bullseye.” The first portion 48 may have a depth 53 (relative to the top surface 22) and a vertical length 55. In an embodiment, the first portion 48 may have a diameter 52 and be substantially cylindrical in shape. The first portion 48 may also take on other shapes, such as a triangle, pentagon, or octagon. It may also take on multiple shapes, such as two circles—one on top of the other, thus depicting two targets 12. In an embodiment, the diameter 52 of the first portion 48 may be about 3⅛ inches and the depth 53 of the first portion 48 may be ⅜ inches. In another embodiment, the diameter 52 of the first portion 48 may be about 1 9/16 inches and the depth 53 of the first portion 48 may be about ⅜ inches. In an embodiment, the mold 10 may contain embodiments of the large size cavity 40 and the small size cavity 38 configured to create a large and small sized free-standing target 12, respectively. The first portion may have the same depth 53 for both the small size cavity 38 and the large size cavity 40 which may then create the same “target area” thickness for the large and small sized targets 12.

In an embodiment, the open-mold cavity 14 may also include at least one fill line indicator 54 which may indicate a desired thickness of the free-standing target 12. In an embodiment, the fill line indicator 54 may be located at the apex of the free-standing target 12 and may be placed such that the formed free-standing target 12 is about ¼ inches thick. Alternatively, the fill line indicator 54 may be located anywhere in the open-mold cavity 14 such as in the second portion 50 or elsewhere in the first portion 48.

The first portion 48 may also have a surface 56 with at least one circumferential protrusion 58. The circumferential protrusion 58 may be configured to create a circular groove 60 in the free-standing target 12. In an embodiment, the first portion 48 may include two concentric circumferential protrusions 58 which may be generally circular in shape. In an embodiment, the circumferential protrusion 58 may project from the surface 56 of the first portion 48 by about 3/32 inches. The circumferential protrusions 58 may serve as indicators of accuracy and inform the user of his skill level relative to other users and/or past use. Moreover, the circumferential protrusions 58 may help the user to visually hone in on the center and, thus, aid in aiming. The circumferential protrusions 58 may also be a shape other than circular. For example, the protrusion 58 may be generally square, in the shape of a logo or design, or even wording. Alternatively, rather than protrusions 58, the first portion 48 may include grooves which would result in protrusions in the free-standing targets 12. The user may choose to add a coloring agent to a section of the “bullseye” and another coloring agent to the other section, thus making the sections more visible.

The second portion 50 may be contiguous with the first portion 48 and have a width 62. In an embodiment, the second portion 50 may be integrally connected to the first portion 48. The second portion 50 may be configured to act as a base, such that the free-standing target 12 is self-supporting. In an embodiment, the second portion 50 may have a base portion 66 comprising a substantially planar support surface (best seen in FIG. 2) configured to contact a ground surface 68 (e.g., the ground, a tabletop, a top of a stump, etc.) and support the free-standing target 12. The second portion 50 may have a depth 64. The depth 64 may be constant throughout the second portion 50, or it may vary and be at its maximum at the substantially planar support surface. In an embodiment, the depth 64 of the second portion 50 may be about double the depth 53 of the first portion 48. For example, in an embodiment, the depth 64 may be ¾ inches and the depth 53 of the first portion 48 may be ⅜ inches. In an embodiment, the base portion 66 may be substantially rectangular in shape. In an embodiment, the base portion 66 may have a pair of grooves 70 aligned substantially parallel to the axis of the depth, where the grooves in the cavity 14 would form a pair of protruding ribs and the ribs may contact the ground surface instead of the substantially planar support surface. In an embodiment, the depth 64 of the second portion 50 may be greater than the depth of the first portion 48, which may result in a free-standing target 12 with a thicker base portion 84, relative to the “target area.” A thicker second portion 50 in the cavity 14 may provide more stability to the free-standing target 12, and may prevent the target 12 from falling over where the first portion 48 (e.g., the target area) is no longer visible to the user due to shattering upon impact. The second portion 50 may have varying widths 62 to accommodate the size of the first portion 48. In an embodiment, the width 62 of the second portion 50 may be about 3⅛ inches and may be coupled with the diameter 52 of the first portion 48 of the large size cavity 40. In another embodiment, the width 62 of the second portion 50 may be about 1 13/16 inches and may be coupled with the smaller diameter first portion 48. A wider second portion 50 to accommodate a larger diameter of the first portion 48 may create a more stable base for the free-standing target 12.

The second portion 50 of the open-mold cavity 14 may also include two side walls 72 each with a first segment 74 and a second segment 76. In an embodiment, the first segment 74 may extend substantially perpendicular from the base portion 66. The second segment 76 of the side wall 72 may then extend inwardly toward the center of the cavity 14 from the first segment 74 and connect with the first portion 48 of the cavity 14. In an embodiment, at an interconnection 78 between the first portion 48 and the second portion 50, the second portion 50 may have a concave shape, while the first portion 48 may have a convex shape (e.g., the arc of the target circle). The interconnection 78 may have a radius substantially similar to a radius of the first portion 48. The volume of the cavity 14 encompassed by the first segment 74 may be substantially rectangular in shape with two chamfered corners. Alternatively, the side walls 72 may each include only one segment 74 which extends inwardly or outwardly from the base portion 66 to the first portion 48 of the cavity 14. In another embodiment, the first segment 72 and second segment 74 of the side walls 72 may both be substantially perpendicular to the base portion 66. For instance, the second segment 76 may extend from a point different than the ending point of the first segment 74, thus creating two substantially rectangular volumes within the second portion 50 of the cavity 14. The open-mold cavity 14 may have a total vertical length 77. In an embodiment, the vertical length 55 of the first portion may be 0.60 the total vertical length. In an embodiment, the total vertical length 77 of the large size cavity 40 from the base portion 66 to the apex of the target area may be about 4 1/16 inches. In another embodiment, the total vertical length 77 of the small size cavity 38 may be about 2 1/16 inches.

FIGS. 3-4 illustrate an embodiment of the free-standing target 12 after removal from the open-mold cavity 14. The free standing target 12 is configured to shatter upon impact with a projectile or other outside force. A first portion 80 (e.g., the “bullseye” portion) of the target 12 corresponding with the first portion 48 of the cavity 14 may shatter upon impact with a projectile and leave the base relatively intact. The first portion 80 of the target 12 may have at least one circular groove 60 formed by the circumferential protrusion 58 located in the first portion 48 of the cavity 14. In an embodiment, the target may have two concentric circular grooves 60. A second portion 82 of the target 12, corresponding with the second portion 50 of the cavity 14, is configured to support both the first portion 80 and the second portion 82 of the target 12. The second portion 82 may have a base portion 84, corresponding with the base portion 66 of the cavity 14. The base portion 84 of the target 12 may directly rest upon and contact the ground surface 68. Although the target 12 may break into several small pieces after impact with a projectile or outside force, no clean-up may be required because the shattered pieces (if made with water or the like) may melt away in time. As a result, no potentially sharp fragments from the shattered remains of the target 12 are left at the shooting area.

Although only certain embodiments have been described above with a certain degree of particularity, those skilled in the art could make numerous alterations to the disclosed embodiments without departing from the scope of this disclosure. Joinder references (e.g., attached, coupled, connected, and the like) are to be construed broadly and may include intermediate members between a connection of elements and relative movement between elements. As such, joinder references do not necessarily infer that two elements are directly connected/coupled and in fixed relation to each other. It is intended that all matter contained in the above description or shown in the accompanying drawings shall be interpreted as illustrative only and not limiting. Changes in detail or structure may be made without departing from the invention as defined in the appended claims.

Any patent, publication, or other disclosure material, in whole or in part, that is said to be incorporated by reference herein is incorporated herein only to the extent that the incorporated materials do not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A mold for making a free-standing target from a frozen water-based liquid, the mold comprising:
at least one open-mold cavity configured to form a free-standing target, the open-mold cavity comprising:
a first portion having a first depth and a first portion vertical length; and
a second portion having a second portion vertical length, and a substantially planar support surface,
wherein the second portion is contiguous with the first portion; the substantially planar support surface is configured to support the free-standing target on a surface; a depth at or about the substantially planar support surface is greater than the first depth of the first portion; the open-mold cavity has a total vertical length; and the vertical length of the first portion is at least 0.60 the total vertical length.

2. The mold of claim 1, wherein the first portion of the open-mold cavity is substantially cylindrical in shape.

3. The mold of claim 1, wherein the first portion of the open-mold cavity includes a surface having at least one protrusion.

4. The mold of claim 1, wherein the first portion of the open-mold cavity includes a surface having two concentric circumferential protrusions.

5. The mold of claim 1, wherein the mold has a hollowed portion located on an underside of the mold.

6. The mold of claim 1, wherein the mold has a substantially constant thickness.

7. The mold of claim 1, wherein the open-mold cavity has a fill line indicator located below the top surface of the mold.

8. The mold of claim 1, wherein a diameter of the first portion is substantially similar to a width of the second portion.

9. The mold of claim 1, wherein the first depth of the first portion is substantially half of the depth of the second portion.

10. The mold of claim 1 wherein the mold is made out of plastic.

11. The mold of claim 1, wherein the mold has a recess running proximate the outer perimeter of the mold upon a top surface of the mold.

12. The mold of claim 1, wherein the mold has a skirt having a constant length located proximate the outer perimeter of the mold.

13. The mold of claim 1, wherein the mold has at least one locator on the top surface of the mold configured to engage a skirt of another mold stacked on top of the mold.

14. The mold of claim 13, wherein the mold has the at least one locator proximate to each corner of the mold.

15. The mold of claim 1, wherein the mold has a plurality of open-mold cavities of variable size.

16. The mold of claim 15, wherein the mold has at least one first open-mold cavity and at least one second open-mold cavity, wherein the first open-mold cavity is larger than the second open-mold cavity.

17. The mold of claim 16, wherein a depth of a first portion of the first open mold cavity and a first portion of the second open mold cavity are substantially similar and a depth of a second portion of the first open mold cavity and a second portion of the second open mold cavity are substantially similar.

18. The mold of claim 15, wherein the mold has at least five first open-mold cavities and at least four second open-mold cavities, wherein the first open-mold cavity is larger than the second open-mold cavity.

19. A mold for making free-standing shooting targets from a frozen water-based liquid, the mold comprising:
at least one first open-mold cavity configured to form a first free-standing target, the first open-mold cavity having a first portion substantially cylindrical in shape, and a second portion generally rectangular in shape, wherein the first portion and the second portion are integrally connected, and a depth of the first portion is smaller than a depth of the second portion relative to a top surface of the mold; and
at least one second open-mold cavity configured to form a second free-standing target, the second open-mold cavity having a first portion substantially cylindrical in shape, and a second portion generally rectangular in shape, wherein the first portion and the second portion are integrally connected, and a depth of the first portion is smaller than a depth of the second portion relative to a top surface of the mold;
wherein a volume of the first open-mold cavity is larger than a volume of the second open-mold cavity.

20. The mold of claim 19, wherein the depth of the first portion of the first open-mold cavity and the depth of the first portion of the second open-mold cavity are substantially the same, relative to a top surface of the mold.
